(19) United States
(12) Patent Application Publication
(10) Pub. No.: US 2008/0120140 A1
(43) Pub. Date: May 22, 2008

(54) Managing medical imaging data

(75) Inventors: Saad Ahmed Sirohey, Pewaukee, WI (US); Istvan Ubelhart, Budapest (HU); Balazs Cziria, Szahalombatta Hungary (HU)

Correspondence Address: DEAN D. SMALL;THE SMALL PATENT LAW GROUP LLP, 611 OLIVE STREET, SUITE 1611, ST. LOUIS, MO, 63101, US

(73) Assignee: GENERAL ELECTRIC COMPANY

(21) Appl. No.: 11/604,093

(22) Filed: Nov. 22, 2006

(51) Int. Cl. G06Q 50/00

(52) U.S. Cl. 705/3

(57) ABSTRACT

A method is provided for managing medical imaging data. The method includes storing location information that indicates a location of an imaging data set created for a medical purpose of a patient in an electronic file created for the medical purpose.

### BACKGROUND OF THE INVENTION

The present invention generally relates to medical imaging data and, more particularly, to managing medical imaging data.

In oncology a patient may go through a series of examinations, such as computed tomography (CT), positron emission tomography (PET), ultrasound, x-ray, magnetic resonance (MR), ultrasonography, single photon emission computed tomography (SPECT), magnetic source imaging, and/or other imaging examinations. The series of examinations is performed to continuously monitor the patient's response to treatment. When evaluating a patient's response to treatment, the previous and follow-up examinations are often analyzed together. The results from the analysis of the follow-up examination may be saved together with results of the analysis of the previous examination(s), for example in a Digital Imaging and Communications in Medicine (DICOM) file, such that the results from all the examinations analyzed are saved in the same file and/or location. Accordingly, information on the progression of the disease throughout the whole series of examinations may be available to the clinician at any time from the same file and/or location.

With new automated analytical tools that measure uptake and/or volumetric information over time, it may be desirable to have the image data of each prior examination of the series available when analyzing follow-up examinations. However, when analyzing the image data of a new follow-up examination, the image data from all of the previous examinations may not be accessible from the workstation at which the image data from the new follow-up examination is being analyzed. For example, although the results from the analysis of all the previous examinations may be saved in the same file and/or location, the file and/or location often does not include image data from the examinations, nor information indicating the location of the image data. Moreover, there is no global depository containing information on where the image data for each of the examinations is located. Accordingly, to review the image data from the previous and the new follow-up examinations together, a doctor or other medical professional often must determine where the image data for the previous examinations is located and manually retrieve the image data therefrom. This can be especially difficult and time-consuming when the image data from previous examinations is stored in different locations.

Some picture archiving and communication systems (PACs) automatically retrieve image data from previous examinations when a new examination is scheduled. However, such PACs retrieve the image data from all historical examinations of the patient, rather than just the series of examinations for the medical purpose being treated, analyzed, identified, monitored, and/or diagnosed.

### BRIEF DESCRIPTION OF THE INVENTION

In one aspect, a method is provided for managing medical imaging data. The method includes storing location information that indicates a location of an imaging data set created for a medical purpose of a patient in an electronic file created for the medical purpose.

In another aspect, a computer readable medium is provided for use with a medical imaging data management system. The medium includes instructions directing the system to store location information that indicates a location of an imaging data set created for a medical purpose of a patient in an electronic file created for the medical purpose.

In another aspect, a method is provided for managing medical imaging data. The method includes storing the results of analyzation of a plurality of imaging data sets within a database, storing within the database location information that indicates a location of the imaging data set of each analyzation result stored within the database, receiving notification that a new imaging data set of a patient has been acquired, comparing the new imaging data set to the analyzation results of the plurality of imaging data sets to determine at least one analyzation result of imaging data sets of the patient within the database that share the same medical purpose of the patient with the new imaging data set, and based on the determined analyzation results, generating a list of at least one imaging data set created for the shared medical purpose of the patient that may be desired for analyzation with the new imaging data set.

### BRIEF DESCRIPTION OF THE DRAWINGS

FIG. 1 is a block diagram of a medical imaging management system formed in accordance with an embodiment of the present invention.

FIG. 2 is a flow chart illustrating a method for managing medical imaging data formed in accordance with an embodiment of the present invention.

FIG. 3 is a flow chart illustrating a method for managing medical imaging data formed in accordance with an alternative embodiment of the present invention.

### DETAILED DESCRIPTION OF THE INVENTION

As used herein, the term “medical purpose of a patient” refers to the treatment, analyzation, identification, monitoring, diagnosis, and/or the like of a particular condition, problem, disease, portion, structure, metabolic activity, and/or the like of the patient.

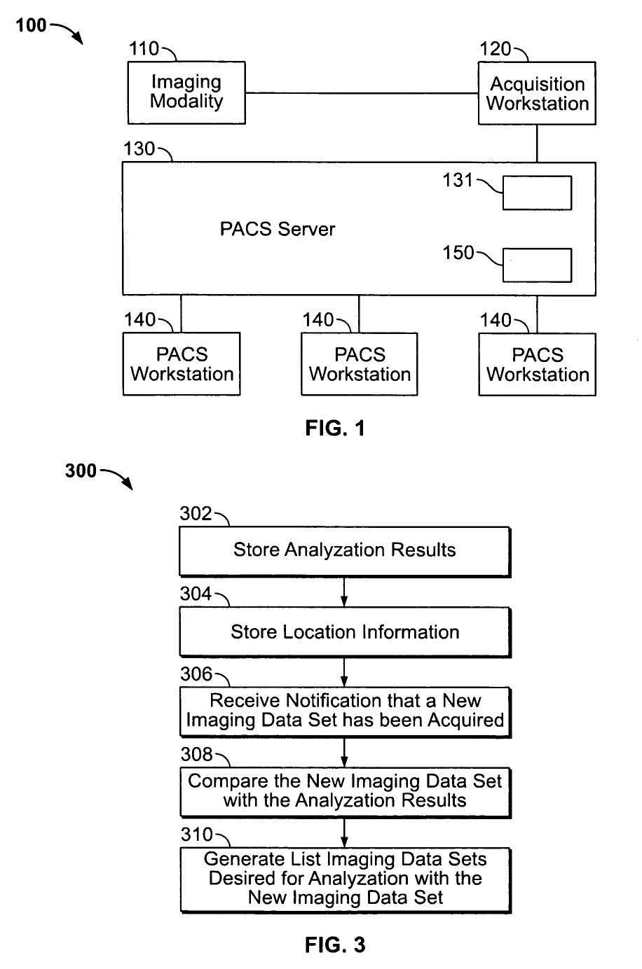

FIG. 1 is a block diagram of a medical imaging management system 100 formed in accordance with an embodiment of the present invention. Although the system 100 is described and illustrated herein as a Picture Archiving and Communication System (PACS) system 200, the system 100 may be any suitable type of system having any suitable component(s) and/or architecture that enable the system 100 to function as described herein. The system 100 includes an imaging modality 110, an acquisition workstation 120, a PACS network server 130, and one or more display workstations 140. The system 100 may include any number of imaging modalities 110, acquisition workstations 120, PAC network servers 130 and display workstations 140 and is not in any way limited to the embodiment of system 100 illustrated in FIG. 1.

In operation, the imaging modality 110 obtains one or more images of a patient anatomy. The imaging modality 110 may include any device capable of capturing an image of a patient anatomy, such as, but not limited to, a medical diagnostic imaging device. For example, the imaging modality 110 may include an X-ray imager, a radiography imager, ultrasound scanner, magnetic resonance (MR) imager, a computed tomography (CT) scanner, a positron emission tomography (PET) scanner, an ultrasonography scanner, a single photon emission computed tomography (SPECT) scanner, a magnetic source imager, a nuclear imaging system, and/or other medical imaging apparatus. Imaging data sets representative of the image(s) is communicated between the imaging modality 110 and the acquisition workstation 120. The imaging data sets may be communicated electronically over a wired or wireless connection, for example. As used herein, an “imaging data set” may include only one or a plurality of images.

In an embodiment, the acquisition workstation 120 may apply one or more preprocessing functions to the imaging data sets in order to prepare the imaging data sets for viewing on a display workstation 140, such as, but not limited to, converting raw imaging data sets into a Digital Imaging and Communications in Medicine (DICOM) standard format and/or attach a DICOM header. The imaging data sets may then be communicated between the acquisition workstation 120 and the PACS network server 130. The image data sets may be communicated electronically over a wired or wireless connection, for example.

The PACS network server 130 may include computer-readable storage media suitable for storing the imaging data sets for later retrieval, viewing, and/or analyzation at a display workstation 140 and/or an acquisition workstation 120. The imaging data sets may be stored anywhere within or external to the system 100, such as, but not limited to, on the server 130, an acquisition workstation 120, and/or a display workstation 140. For example, imaging data sets for a variety of different patients and/or for a variety of different medical purposes of one or more of the patients may be stored at various different locations within the system 100, whether grouped together by the patient or not.

The PACS network server 130 may also include one or more software applications for additional processing and/or preprocessing of the image data by one or more display workstations 140 and/or acquisition workstations 120, for example. For example, one or more imaging data sets may be automatically analyzed using any suitable automated image assessment package, such as, but not limited to, an automated package that measures uptake and/or volumetric information over time.

One or more display workstations 140 and/or acquisition workstations 120 are capable of or configured to communicate with the server 130. The workstations 140 and/or 120 may include a general purpose processing circuit, a network server 130 interface, a software memory, and/or an image display monitor, for example. The network server 130 interface may be implemented as a network card connecting to a TCP/IP based network, but may also be implemented as a parallel port interface, for example.

The display workstations 140 and/or the acquisition workstations 120 may retrieve or receive image data from the server 130 for display to one or more users. For example, a workstation 120 and/or 140 may retrieve or receive image data representative of a computed radiography (CR) image of a patient's chest. A radiologist may then examine the image for any objects of interest such as tumors, lesions, etc.

The display workstations 140 and/or the acquisition workstations 120 may also be capable of or configured to apply processing functions to image data. For example, the workstations 120 and/or 140 may be capable of or configured to automatically analyze imaging data sets using the automated image assessment package described above, which may be stored on the server 130 and/or on the workstations 120 and/or 140. Other exemplary processing functions include, but are not limited to, enhancing features within an image representative of the image data (for example to adjust an image of a patient anatomy in order to ease a user's diagnosis of the image), and/or any software-based application that may alter a visual appearance or representation of image data, such as, but not limited to, flipping an image, zooming in an image, panning across an image, altering a window and/or level in a grayscale representation of the image data, and/or altering a contrast and/or brightness an image.

In some embodiments, the display workstations 140 and/or the acquisitions workstations 120 include interfaces (not shown) capable of allowing control of and exchange of information at the corresponding workstations 140, 120. The interface may be a graphical user interface (GUI) or other user interface that may be configured to allow a user to access functionality at the corresponding workstation 140, 120. The interface may be connected to an input device, such as a keyboard, mouse device, touch screen, and/or other input device, for example.

In some embodiments, the display workstations 140 and/or the acquisition workstations 120 may include communication devices (not shown) to allow communication between the corresponding workstation 140, 120 and other components of the system 100 or external to the system 100. The communication devices may include, but are not limited to, a modem, wireless modem, cable modem, Bluetooth™ wireless device, infrared communication device, wired communication device, and/or other communication device, for example. The communication devices communicate and transfer data via one or more communication protocols, such as the DICOM protocol. The communication devices coordinate with processors (not shown) in the workstations 120, 140 to establish a connection between the workstations 120, 140 and remotely execute functionality and/or transfer data, for example.

The system 100 may store, receive, transmit, and/or generate imaging data sets and associated data, such as, but not limited to, DICOM data. For some medical purposes of a patient, a series of imaging data sets are acquired, or created, over time and analyzed to continuously monitor the patient's response to treatment. When evaluating a patient's response to treatment, some or all of the series of imaging data sets are often analyzed together. For example, when a new follow-up imaging data set is acquired for a particular medical purpose of a patient, the results may be analyzed with the directly previous imaging data set or all previous imaging data sets created for that particular medical purpose of the patient. Accordingly, the results from each analysis for a particular medical purpose of a patient are saved together in the same electronic file 150 that has been created for the particular medical purpose of the patient. The electronic file 150 may be any suitable file type enabling the electronic file 150 to function as described herein. The electronic file 150 includes the results from each analysis, as well as the name of each imaging data set created for the particular medical purpose of the patient that the electronic file 150 is associated with. In some embodiments, the electronic file 150 may also include a time, a date, and/or an identification, such as, but not limited to, a unique identification number, for each imaging data set created for the particular medical purpose of the patient that the electronic file 150 is associated with. The electronic file 150 also includes location information linked to each imaging data set created for the particular medical purpose of the patient that the electronic file 150 is associated with. The location information indicates a location of the corresponding imaging data set such that the corresponding imaging data set can be retrieved for analyzation. The location information may be any suitable information in any suitable format that enables the location information to function as described herein, such as, but not limited to, metadata. The electronic file 150 may also include other information relating to the particular medical purpose of the patient that the electronic file is associated with.

The imaging data sets may each be located anywhere within or external to the system 100, such as, but not limited to, the server 130, an acquisition workstation 120, a display workstation 140, a server (not shown) and/or workstation (not shown) external to the system 100, and/or a recording medium such as, but not limited to, a disk, a CD-ROM, and/or a DVD-ROM. The imaging data sets may each be retrieved in any suitable manner, such as, but not limited to, automatically by a workstation 140 and/or 120 using the system 100, manually via input from a user using the workstation 140 and/or 120, and/or manually by user obtaining a recording medium and loading the imaging data set(s) from the recording medium to the workstation 140 and/or 120.

Although shown as being stored within the server 130, the electronic file 150 may be stored anywhere within or external to the system 100, such as, but not limited to, on the server 130, an acquisition workstation 120, and/or a display workstation 140. In some embodiments, the system 100 includes a database 131 that stores a plurality of electronic files 150. Each electronic file 150 stored within the database is created for, or associated with, a different medical purpose. The database may include a plurality of electronic files 150 created for, or associated with, different medical purposes of the same patient, and/or a plurality of electronic files 150 created for, or associated with, different patients. Although the database 131 is shown as being contained within the PACS server 130, the database 131 may be located anywhere within or external to the system 100, such as, but not limited to, the server 130, an acquisition workstation 120, a display workstation 140, a server (not shown) and/or workstation (not shown) external to the system 100, and/or a recording medium such as, but not limited to, a disk, a CD-ROM, and/or a DVD-ROM.

In an alternative embodiment, rather than creating an electronic file 150 for each medical purpose of each patient, the database 131 stores the information stored by each of the electronic files 150 (e.g., the analyzation results and/or the names, dates, identifications, and/or location information of the imaging data sets) in an unsegmented manner, i.e., such that the information stored by each of the electronic files 150 in other embodiments is not grouped together in the database by shared medical purposes and/or shared patients. Exemplary operation of this alternative embodiment is described below with respect to FIG. 3.

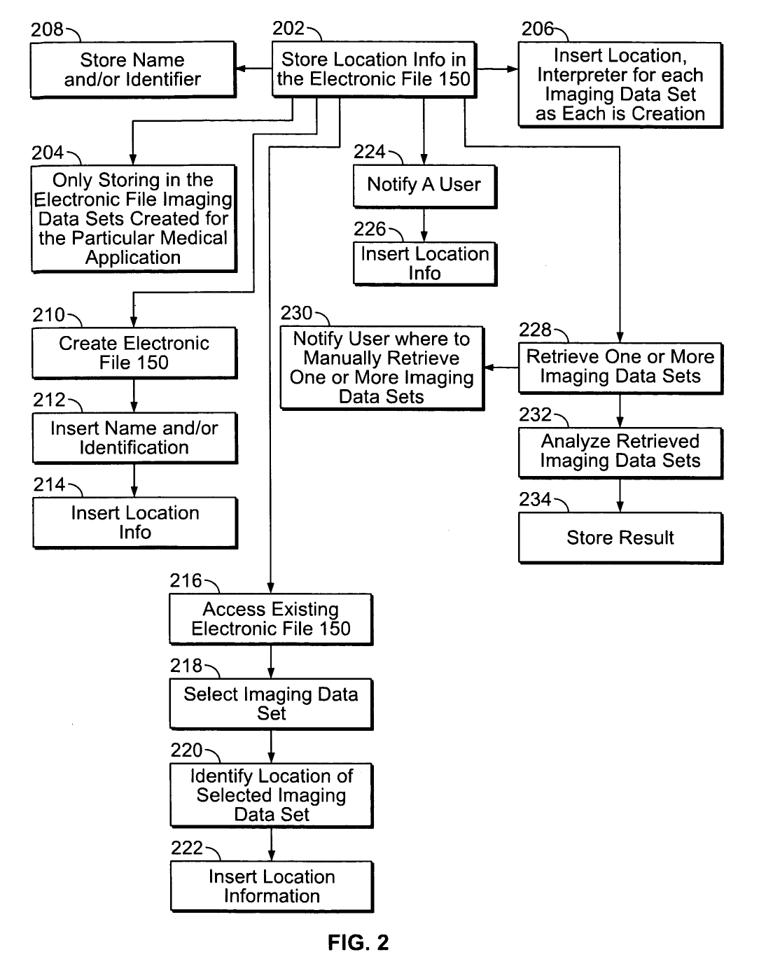

FIG. 2 is a flow chart illustrating a method 200 for managing medical imaging data formed in accordance with an embodiment of the present invention. Although the method 200 is described and illustrated herein as being at least partially performed using the system 100 (shown in FIG. 1), the method 200 may be completely or partially performed using any suitable system enabling such complete or partial performance. The method 200 includes using the system 100 to store 202 location information that indicates a location of an imaging data set created for a particular medical purpose of a patient in an electronic file 150 (shown in FIG. 1) that was created for, or is associated with, the particular medical purpose. The method 200 may also include only storing 204 in the electronic file 150 imaging data sets that were acquired for the particular medical purpose of the patient for which the electronic file 150 was created. In other words, imaging data sets of the patient that were not created for the particular medical purpose for which the electronic file 150 was created are not stored within the electronic file. When a series of imaging data sets have been created for the particular medical purpose over time, the method 200 may include using the system 100 to insert 206 location information for each of the imaging data sets into the electronic file 150 as each imaging data set is created. The method 200 may also include storing 208 a name and/or an identification, such as, but not limited to, a unique identification number, for each imaging data set created for the particular medical purpose of the patient that the electronic file 150 is associated with.

In some embodiments, the electronic file 150 is created 210 before, during, or after a first imaging data set has been acquired for the particular medical purpose of the patient. Once the file 150 has been created 210, a name and/or an identification of the first imaging data set can be inserted 212 into the electronic file 150, and the location information for the first imaging data set can be inserted 214 into the file 150. The creation 210, insertion 212, and/or insertion 214 may be performed manually by a user, for example using a workstation 140 and/or a workstation 120, or may be automatically performed by the system 100.

In addition to creating new electronic files for new medical purposes, as discussed above in the preceding paragraph, in some embodiments, the method 100 may include updating existing, or previously created, electronic files 150 for existing medical purposes of patients. For example, the method 100 may include accessing 216 an existing electronic file 150, and selecting 218 an imaging data set from one or more names and/or identifications of existing imaging data sets that were created for the medical purpose of which the existing electronic file 150 is associated with. The location of the selected existing imaging data set can then be identified, or determined, 220, and the location information indicating the identified location can be inserted 222 into the existing electronic file 150 and linked with the corresponding existing imaging data set. The accessing 216, selecting 218, identification 220, and/or insertion 222 may be performed manually by a user, for example using a workstation 140 and/or a workstation 120, or may be automatically performed by the system 100.

In some embodiments, the method 200 includes notifying 224 a user, for example on a workstation 140 (shown in FIG. 1) and/or a workstation 120 (shown in FIG. 1) that a new imaging data set has been acquired, or is to be acquired, for a particular medical purpose. The notification 224 may be manually entered by a user, for example using a workstation 140 and/or a workstation 120. Additionally or alternatively, the notification 224 may be automatically performed by the system 100. After notification 224, the location information for the new imaging data set can be inserted 226 into the electronic file 150 created for the particular medical purpose. Insertion 226 may be performed manually by a user, for example using a workstation 140 and/or a workstation 120, and/or automatically by the system 100.

Using the location information stored within the electronic file 150 associated with a particular medical purpose of a patient, a user can retrieve 228 some or all of the imaging data sets created for the particular medical purpose from their corresponding locations, for example using a workstation 120 and/or a workstation 140. The retrieval 228 may be performed manually by a user, for example using a workstation 140 and/or a workstation 120 to load imaging data set(s) to the workstation 140 and/or 120 by retrieving the imaging data set(s) electronically through the system 100. Additionally, or alternatively, the system 100 may automatically retrieve 228 and load the imaging data set(s) on the workstation 140 and/or 120. In some embodiments, the system 100 notifies 230 a user where the user can manually retrieve the imaging data set, for example from a recording medium that is then loaded into the workstation 140 and/or 120. Once one or more imaging data sets are retrieved for the particular medical purpose, the imaging data set(s) can be analyzed 232, for example using an automated image assessment package as described above. The results of the analyzation 232, as well as any subsequent analyzations of imaging data sets subsequently created for the particular medical purpose, are stored 234 within the electronic file 150 associated with the particular medical purpose.

FIG. 3 is a flow chart illustrating a method 300 for managing medical imaging data formed in accordance with an alternative embodiment of the present invention. Specifically, the method 300 may be used with the alternative embodiment described above wherein rather than creating an electronic file 150 for each medical purpose of each patient, the database 131 stores, in an unsegmented manner, the information stored by each of the electronic files 150 in other embodiments. Although the method 300 is described and illustrated herein as being at least partially performed using the system 100 (shown in FIG. 1), the method 300 may be completely or partially performed using any suitable system enabling such complete or partial performance.

The method 300 includes storing 302 the results of analyzation of a plurality of imaging data sets within the database 131 (shown in FIG. 1), and storing 304 within the database location information that indicates a location of the imaging data set of each analyzation result stored within the database 131. The method 300 also includes receiving 306 notification that a new imaging data set of a patient has been acquired, and comparing 308 the new imaging data set to the analyzation results of the plurality of imaging data sets to determine one or more analyzation results of imaging data sets of the patient within the database 131 that share the same medical purpose of the patient with the new imaging data set. In some embodiments, comparing 308 includes comparing a name and/or an identification of the new imaging set with names and/or identifications of the analyzation results. Based on the determined analyzation results, a list is generated 310 of one or more imaging data sets created for the shared medical purpose of the patient that may be desired for analyzation with the new imaging data set. Other operations, such as, but not limited to, notification, retrieval, and analyzation, of this alternative embodiment described with respect to FIG. 3 (and also described in a portion of the description of FIG. 1) are similar to that of the electronic folder 150 embodiments described in FIGS. 1 and 2, and therefore will not be described in more detail herein.

The embodiments described herein may facilitate easier management of medical imaging data. For example, the embodiments described herein may facilitate easier management of medical imaging data for a particular medical purpose of a patient.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step, can also be used in combination with other components and/or steps. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

What is claimed is:

1. A method for managing medical imaging data, said method comprising storing location information that indicates a location of an imaging data set created for a medical purpose of a patient in an electronic file created for the medical purpose.

2. The method according to claim 1, wherein two imaging data sets are created for the medical purpose at least one of at different times and using different imaging modalities, and storing location information comprises inserting location information that indicates a location of each of the imaging data sets created at least one at different times and using different imaging modalities into the electronic file as each imaging data set is created.

3. The method according to claim 1, further comprising:
creating the electronic file for the medical purpose;
inserting an identification that associates the imaging data set with the medical purpose into the electronic file; and
inserting the location information into the electronic file.

4. The method according to claim 1, wherein the location information comprises a metadata format.

5. The method according to claim 1, further comprising storing at least one of a name of the imaging data set, an identification of the imaging data set, a time of the imaging data set, and a date of the imaging data set in the electronic file.

6. The method according to claim 1, further comprising:
accessing the electronic file;
using the location information to identify the location of the imaging data set; and
retrieving the imaging data set from the location thereof.

7. The method according to claim 1, further comprising analyzing the imaging data set using an automated image assessment package.

8. The method according to claim 1, further comprising:
retrieving the imaging data set and another imaging data set created for the medical purpose; and
analyzing the imaging data set and the other imaging data set together.

9. The method according to claim 1, further comprising storing the results of analyzation of the imaging data set in the electronic file.

10. A computer readable medium for use with a medical imaging data management system, the medium comprising instructions directing the system to store location information that indicates a location of an imaging data set created for a medical purpose of a patient in an electronic file created for the medical purpose.

11. The medium according to claim 10, wherein two imaging data sets are created for the medical purpose at least one of at different times and using different imaging modalities, and the medium comprises instructions directing the system to insert location information that indicates a location of each of the imaging data sets created at least one of at different times and using different imaging modalities into the electronic file as each imaging data set is created.

12. The medium according to claim 10, wherein a first imaging data set and a second imaging data set are created for the medical purpose at different times, and the medium further comprises instructions directing the system to:
notify a user that the second imaging data set has been created; and
insert location information that indicates a location of the second imaging data set into the electronic file.

13. The medium according to claim 10, wherein a first imaging data set and a second imaging data set are created for the medical purpose at different times, and the medium further comprises instructions directing the system to:
notify a user that the second imaging data set has been created; and
enable the user to insert location information that indicates a location of the second imaging data set into the electronic file.

14. The medium according to claim 10, wherein the location information comprises a metadata format.

15. The medium according to claim 10, further comprising instructions directing the system to not store location information for any imaging data sets of the patient that were not created for the medical purpose of the patient in the electronic file.

16. The medium according to claim 10, further comprising instructions directing the system to store at least one of a name of the imaging data set, an identification of the imaging data set, a time of the imaging data set, and a date of the imaging data set in the electronic file.

17. The medium according to claim 10, further comprising instructions directing the system to:
access the electronic file;
use the location information to identify the location of the imaging data set; and
one of retrieve the imaging data set from the location thereof and notify a user the location from where the user can manually retrieve the imaging data set.

18. The medium according to claim 10, further comprising instructions directing the system to enable a user to perform at least one of the steps of claim 17.

19. The medium according to claim 10, further comprising instructions directing the system to analyze the imaging data set using an automated image assessment package.

20. The medium according to claim 10, further comprising instructions directing the system to:
retrieve the imaging data set and another imaging data set created for the medical purpose; and
analyze the imaging data set and the other imaging data set together.

21. The medium according to claim 10, further comprising instructions directing the system to store the results of analyzation of the imaging data set in the electronic file.

22. A method for managing medical imaging data, said method comprising:
storing the results of analyzation of a plurality of imaging data sets within a database;
storing within the database location information that indicates a location of the imaging data set of each analyzation result stored within the database;
receiving notification that a new imaging data set of a patient has been acquired;
comparing the new imaging data set to the analyzation results of the plurality of imaging data sets to determine at least one analyzation result of imaging data sets of the patient within the database that share the same medical purpose of the patient with the new imaging data set; and
based on the determined analyzation results, generating a list of at least one imaging data set created for the shared medical purpose of the patient that may be desired for analyzation with the new imaging data set.

23. The method according to claim 22, further comprising retrieving the listed at least one imaging data set from the locations indicated in the corresponding location information stored within the database.

24. The method according to claim 22, wherein comparing the new imaging data set comprises comparing at least one of a name and an identification of the new imaging data set with at least one of a name and an identification of the analyzation results of the plurality of imaging data sets.

25. The method according to claim 22, wherein storing the results of analyzation of a plurality of imaging data sets within a database comprises storing analyzation results of the plurality of imaging data sets that are at least one of for a plurality of different patients and for a plurality of different medical purposes.
